(19) United States
(12) Patent Application Publication
(10) Pub. No.: US 2004/0058680 A1
(43) Pub. Date: Mar. 25, 2004

(54) Method of performing soft handover in a mobile communications system

(76) Inventors: Xinjie Yang, Xinjiang Autonomous Region (CN); Shahram Ghaheri-Niri, Surrey (GB); Rahim Tafazolli, Surrey (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/432,116

(22) PCT Filed: Nov. 15, 2001
(86) PCT No.: PCT/GB01/05059

(30) Foreign Application Priority Data
Nov. 17, 2000 (GB) 0028112.1

(51) Int. Cl. H04Q 7/20

(52) U.S. Cl. 455/442

(57) ABSTRACT

A method of performing soft handover in a mobile communications system includes the steps of estimating a value of signal strengthfor the next sampling period and basing at least one threshold onthat value.

This invention relates to a method of performing soft handover in a mobile communications system, particularly though not exclusively in a CDMA (Code Division Multiple Access) cellular system.

In CDMA based mobile communication systems, handover handles the continuity of traffic and signalling flows when a mobile terminal moves, and changes its access point to the network. Generally in GSM (Global System for Mobile Communications) the mobile terminal is in contact with only one base station (BS) at any one time. A so-called “hard handover” occurs when the connection to the current base station is broken and a new connection is immediately made to the target base station. In contrast, a soft handover process has been proposed and implemented in IS-95 [Mobile Station-Base Station Compatibility for Dual-Mode Wideband Spread Spectrum Cellular System, EIA/TIA/IS-95 Interim Standard, Telecommunications Industry Association, July 1993]. In this handover process the mobile terminal may communicate with multiple base stations simultaneously. All the base stations currently connected to and communicating with the mobile terminal form a so-called “active set”.

Soft handover has several advantages; it provides a diversity gain to and from the mobile terminals in the handover and the quality of service (QoS) is improved due to the extra links available. These advantages lead to an extended forward link and a higher uplink capacity [A. J. Viterbi et al., “Soft Handoff Extends CDMA Cell Coverage and Increases Reverse Link Capacity”, IEEE J. Select. Areas Commun., Vol 12 No. 8 pp1281-97, October 1994]. The soft handover process also greatly reduces the Ping-Pang effect, where fluctuations in signal strength on the edge of a cell lead to many forwards and backwards handovers. In TDMA (Time Division Multiple Access) systems where the Ping-Pang effect occurs hysteresis has to be used to compensate. However, soft handover methods that are currently used also have disadvantages, including a higher downlink interference (due to the high number of base station subsystems (BSS) in the active set) and a requirement for more complex implementation.

Efficient design of soft handover is a major challenge in mobile telecommunications since it has a great impact on the system performance, capacity and infrastructure cost. In hard handover a definite decision is made on whether to hand over from one base station to a different base station. In comparison, in the soft handover process a conditional decision on whether to handover is made, based on a variety of parameters involving several base stations. Consequently soft handover design and parameter optimisation is much more complex compared to hard handover.

Hitherto, a set of system parameters have been defined for a method of performing a soft handover. These include TADD, an adding threshold, TDROP, a dropping threshold and TTDROP, the dropping time. The basic principle of the soft handover method is as follows. If the signal strength from a new base station, currently not connected to the mobile terminal exceeds TADD, then that base station is added to the active set for that mobile terminal and starts to communicate with the user. When the signal strength from a base station in the active set falls below TDROP for a period of time TTDROP, then that base station is removed from the active set and is no longer connected to the mobile terminal. Different designs of these parameters lead to different methods of performing a soft handover and these different methods have different effects on the system performance.

The effectiveness of a particular soft handover method can be evaluated in terms of one or more performance indicators which include:

(1) Mean active set number. This is defined as the average number of base stations serving one user (mobile terminal) at a given time. This performance indicator represents the number of downlink traffic channels supporting the user in a soft handover system and can be considered as a measure of the system resource efficiency.

(2) Active set update rate. This is defined as the number of changes in the user's active set per second. This performance indicator can be considered as a measure of the signalling load.

(3) Outage probability. This is defined as the probability that the maximum signal strength P_{MAX} in the active set falls below Treceive, where Treceive is the lower bound of the acceptable signal strength. This performance indicator is used to describe the quality of the service.

In early methods for performing soft handover, TADD and TDROP were fixed [P. Seite, “Soft Handoff in DS-CDMA Microcellular Network”, IEEE VTC, Stockholm, Sweden, June 1994 pp530-34]. This resulted in an undesirably high outage probability, since the method could not always guarantee that the user was always communicating with the optimum base station. To overcome this, methods involving dynamic threshold values have been adopted.

In IS-95, a single dynamic threshold soft handover method was proposed. In this method, TADD is the dynamic variable and is related to the signal strength in the active set, TDROP is preset at a known constant value. Such a method is given below in reference 1.

### Reference 1

Method for Performing a Soft Handover With a Single Dynamic Threshold

TADD=max {P_{MAX}, TDROP}

TDROP=preset value

P_{MAX} is the maximum signal strength in the active set. In this method TDROP is the lower bound of TADD ensuring that TADD is never less than TDROP.

Methods of performing a soft handover using double dynamic thresholds have also been proposed [N. Zhang, J. M. Holtzman, “Analysis of a CDMA Soft-Handoff Algorithm”, IEEE Trans. Veh. Technol., Vol 47, No. 2, pp710-14, May 1998 and the CDMA 2000 RTT Submission to ITU-R, U.S. TG8/1, 26 June 1998]. In these methods TADD is related to the signal strength in the active set and the difference between TADD and TDROP is maintained at a constant value. Such a method is given below in reference 2.

### Reference 2

Method for Performing a Soft Handover With a Double Dynamic Threshold

TADD=max {P_{MAX}, TDROP}

TDROP=max {P_{MAX}-Con, Treceive}

Here, Con represents a constant in dB according to the system requirements.

These dynamic threshold soft handover methods can reach a low outage probability.

However it is difficult to optimise the system parameters to achieve the desired values of the performance indicators. In both of these dynamic soft handover methods, TADD traces the values of the signal strength in the active set and the relationship between these two is linear. However the outage probability is a non-linear function and is not easy to optimise.

In the case of the method using a single dynamic threshold, the active set update rate and the outage probability always increase when the mean active set number decreases. Similarly a decrease in active set update rate leads to an undesirably high mean active set number. To produce a similar outage probability for the double dynamic threshold method is achieved with a low active set number but an undesirably high update rate [X. Yang et al “Soft Handover Algorithms Evaluation for UTMS System”, Internal Report, CCSR, University of Surrey, UK 1999].

According to the invention there is provided a method of performing soft handover in a mobile communications system, where the system comprises a mobile terminal and a number of base stations and the base stations in communication with the terminal define an active set, the method comprising the steps of removing a said base station from the active set if a measure of signal strength from said base station for a current sampling period is less than a dropping threshold (TDROP) and adding a said base station to the active step if a measure of signal strength from said base station exceeds an adding threshold TADD the method being characterised by the steps of estimating a value of signal strength for the next sampling period and setting at least one of said thresholds in dependence on said value.

Based on knowledge of auto-correlation between two shadowing samples, the probability that an outage happens at the next step can be estimated. Therefore dynamic TADD and TDROP can be designed according to the desired outage probability.

A first implementation of a dynamic soft handover method in accordance with the invention will now be described.

In this implementation, the HATA model of path loss (M Hata, “Empirical formula for propagation loss in land mobile radio service”, IEEE Transaction on Vehicular Technology—vol 29, no3. August 1980) corresponding to the UMTS (Universal Mobile Telecommunication System) vehicular test environment is chosen, as described in ETSI's, “Selection procedures for the choice of radio transmission technologies of the UTMS. UTMS 30.03 version 3.1.0, TR 101 112”. The shadowing of the signal (in dB) is given by a Gaussian process, with a mean of zero and a standard derivation of σ. The auto correlation function between two adjacent shadowing samples is described by a negative exponential function [M. Gudmundson, “Correlation Model for Shadow Fading in Mobile Radio Systems”, IEEE Electron. Lett., 1991, Vol 27, No. 23]. The effect of fast fading is assumed to be averaged out due to its short correlation length.

The n^{th} signal sample received from the i^{th} base station BSᵢ is

x_{i,n}=m_{i,n}+ζ_{i,n} (1)

where m_{i,n} is the mean of the signal sample and is determined by the transmit power of the base station, BSᵢ, and the corresponding path loss and where ζ_{i,n} is the shadowing of the signal experienced by the user.

To reduce derivation of the signal, N successively received samples are averaged. Thus, the n^{th} signal sample received from BSᵢ, after signal averaging, is

$$\begin{matrix}{\overline{x}}_{i , n} = \frac{1}{N} {\sum }_{k = 0}^{N - 1} {x}_{i , n - k} = \frac{1}{N} {\sum }_{k = 0}^{N - 1} ( {m}_{i , n - k} ) + \frac{1}{N} {\sum }_{k = 0}^{N - 1} ( {}_{i , n - k} ) \\ = {\overline{m}}_{i , n} + {\overline{}}_{i , n}\end{matrix} \qquad ( 2 )$$

The standard σ_{A} derivation of this averaged shadowing sample, \overline{ζ}_{i,n} is given by:

$${σ}_{A} = \frac{σ}{N} {( N + 2 {\sum }_{k = 1}^{N - 1} ( N - k ) {r}^{k} )}^{1 / 2} \qquad ( 3 )$$

where,

$$r = exp [ - \frac{\vert Δ x \vert}{{X}_{c}} ]$$

is the normalised auto-correlation coefficient of two adjacent shadowing samples with distance Δx between them and an effective de-correlation length X_{c}.

If it is assumed that the average path losses from BSᵢ for the n^{th} and (n+1)^{th} samples are nearly the same, because of the high sampling rate, then the (n+1)^{th} average signal sample received from BSᵢ can be estimated from the n^{th} averaged signal sample by:

$$\begin{matrix}{\overline{x}}_{i , n + 1} = {\overline{m}}_{i , n + 1} + {\overline{ς}}_{i , n + 1} \\ = {\overline{x}}_{i , n} - ( 1 - {r}_{A} ) {\overline{}}_{i , n} + \sqrt{1 - {r}_{A}^{2}} {}_{A} ,\end{matrix} \qquad ( 4 )$$

where ζ_{A} is a Gaussian random variable with a mean of zero and standard derivation σ_{A} and is independent of \overline{ζ}_{i,n} and \overline{ζ}_{i,n+1}, and where r_{A} represents the normalized auto-correlation coefficient of two adjacent averaged shadowing samples and is given by:

$${r}_{A} = \frac{E ⟨ {\overline{ς}}_{i , n} {\overline{ς}}_{i , n + 1} ⟩}{{σ}_{A}^{2}} = 1 - \frac{1 - {r}^{N}}{N + 2 {\sum }_{k = 1}^{N - 1} \cdot ( N - k ) {r}^{k}} \qquad ( 5 )$$

From the estimation of \overline{x}_{i,n+1}, the probability that the next average signal sample received from BSᵢ is less than TDROP can be derived as

$$\begin{matrix}{P}_{d , i} ( {\overline{x}}_{i , n + 1} \vert {\overline{x}}_{i , n} ) = Pr \{ {\overline{x}}_{i , n + 1} < T\_DROP \vert {\overline{x}}_{i , n} \} \\ = Pr \{ {\overline{x}}_{i , n} - ( 1 - {r}_{A} ) {\overline{ζ}}_{i , n} + \sqrt{1 - {r}_{A}^{2}} {ζ}_{A} < T\_DROP \} \\ = Pr \{ {\overline{ζ}}_{i , n} > \frac{\sqrt{1 - {r}_{A}^{2}} {ζ}_{A} + {\overline{x}}_{i , n} - T\_DROP}{1 - {r}_{A}} \} \\ = \frac{1}{2 π {σ}_{A}^{2}} {\int }_{- ∞}^{+ ∞} {ⅇ}^{- \frac{{y}^{2}}{2 {σ}_{A}^{2}}} {\int }_{\frac{\sqrt{1 - {r}_{A}^{2}} y + {\overline{x}}_{i , n} - T\_DROP}{1 - {r}_{A}}}^{+ ∞} {ⅇ}^{- \frac{{x}^{2}}{2 {σ}_{A}^{2}}} ⅆ x ⅆ y \\ = Q ( \frac{\sqrt{1 + {r}_{A}}}{\sqrt{2} ( 1 - {r}_{A} )} \cdot \frac{{\overline{x}}_{i , n} - T\_DROP}{{σ}_{A}} )\end{matrix} \qquad ( 6 )$$

This last equation follows from the circular symmetry of the joint density function and the linear boundary of the region of integration.

If it is assumed that there are K base stations in the active set at the n^{th} step and that the averaged signals from the K base stations are all independent, then the probability that all the averaged signal samples in the active set fall below TDROP at the (n+1)^{th} step, (i.e. none of the signals in the active set will qualify at the (n+1)^{th} step) is given by:

$${P}_{d} ( n + 1 ) = {\prod }_{j = 1}^{K} {P}_{dj} ( {\overline{x}}_{j , n + 1} \vert {\overline{x}}_{j , n} ) \qquad ( 7 )$$

If the signal strength from BSᵢ is maximum at the n^{th} sample then

P_{dj}(\overline{x}_{i,n+1}|\overline{x}_{i,n})≦P_{dj}(\overline{x}_{j,n+1}|\overline{x}_{j,n});1≦j≦Kj≠i (8)

Therefore,

P_{d}(n+1)≦m in{P_{dj}(\overline{x}_{j,n+1}|\overline{x}_{j,n});1≦j≦K}=P_{dj}(\overline{x}_{i,n+1}|\overline{x}_{i,n}) (9)

Since Treceive is less than TDROP, P_{d}(n+1) can be treated as the upper bound of the outage probability at the next step. By fixing TDROP and making TADD a dynamic variable with value \overline{x}_{i,n} at the n^{th} step the method defined in Reference 1 above is obtained.

However, when x_{i,n} is very high then P_{d}(n+1) may be very low.

Therefore, a reference signal value\overline{x}_{R} can be defined and it can be assumed that when \overline{x}_{i,n} is higher than \overline{x}_{R} P_{d}(n+1) is small enough that no new base stations need be added to the active set. P_{R} is defined as the probability that \overline{x}_{R} falls below TDROP at the (n+1)^{th} step. Therefore, from Equation 6, the following expression can be obtained:

$${\overline{x}}_{R} = TDROP + \frac{\sqrt{2} ( 1 - {r}_{A} )}{\sqrt{1 + {r}_{A}}} {σ}_{A} \cdot {Q}^{- 1} ( {P}_{R} ) \qquad ( 10 )$$

Due to the fact that the higher \overline{x}_{i,n} the less necessary it is to add new base stations to the active set a similar Q function can be defined and added to TADD.

TDROP is a fixed threshold and is treated as the lower bound of TADD and so the value of TADD can be expressed as:

$$TADD = \{ \begin{matrix}+ ∞ & {P}_{MAX} > {\overline{x}}_{R} \\ {P}_{MAX} + A \cdot Q ( B \cdot \frac{{\overline{x}}_{R} - {P}_{MAX}}{{σ}_{A}} ) & T\_DROP \leq {P}_{MAX} \leq {\overline{x}}_{R} \\ T\_DROP & {P}_{MAX} < T\_DROP \end{matrix} \qquad ( 11 )$$

where A and B are parameters to adjust the shape of TADD. This defines a new single dynamic threshold based method which is an improvement to the single dynamic threshold based method given in Reference 1 above.

In a further embodiment of the invention a double dynamic threshold method for performing soft handover is adpoted. In this case, TADD is set to the maximum signal strength in the active set (assumed to be from BSᵢ at the n^{th} step).

The dynamic value of TDROP is derived from Equation 9 as:

$$\begin{matrix}TDROP \leq {\overline{x}}_{i , n} - \frac{\sqrt{2} ( 1 - {r}_{A} )}{\sqrt{1 + {r}_{A}}} {σ}_{A} \cdot {Q}^{- 1} ( {P}_{d} ( n + 1 ) ) = \\ TADD - \frac{\sqrt{2} ( 1 - {r}_{A} )}{\sqrt{1 + {r}_{A}}} \cdot {σ}_{A} \cdot {Q}^{- 1} ( {P}_{d} ( n + 1 ) )\end{matrix} \qquad ( 12 )$$

An optimised value of TDROP can be designed for a given function of P_{d}(n+1) in the upper bound of the outage probability. In cases when P_{d}(n+1) is constant for all situations then the difference between TADD and TDROP will be constant. This will result in the method given in Reference 2.

However, when \overline{x}_{i,n} is higher, the link to BSᵢ is more stable and there are fewer base stations in the active set and so P_{d}(n+1) can be reduced to keep the current links and reduce the active set update rate. Therefore, P_{d}(n+1) should be dynamically adjusted according to the users situation. The dynamic P_{d}(n+1) can be designed in different ways as a function of P_{MAX}. The value of TDROP is then given by:

$$T\_DROP = \{ \begin{matrix}{\overline{x}}_{R} - Con . & {P}_{MAX} > {\overline{x}}_{R} \\ T\_ADD - Con . & T\_receive + Con . \leq {P}_{MAX} \leq {\overline{x}}_{R} \\ T\_receive & {P}_{MAX} < T\_receive + Con .\end{matrix} \qquad ( 13 )$$

where \overline{x}_{R} is the reference value defined earlier.

These embodiments described herein for performing a soft handover provide a considerable reduction in the active set update rate whilst maintaining a low outage probability and relatively low mean active set number (Base Station Subsystem) number in the active set.

1. A method of performing soft handover in a mobile communications system, where the system comprises a mobile terminal and a number of base stations and the base stations in communication with the terminal define an active set, the method comprising the steps of removing a said base station from the active set if a measure of signal strength from said base station for a current sampling period is less than a dropping threshold (TDROP) and adding a said base station to the active step if a measure of signal strength from said base station exceeds an adding threshold TADD the method being characterised by the steps of estimating a value of signal strength for the next sampling period and setting at least one of said thresholds in dependence on said value.

2. A method as claimed in claim 1 wherein said measure of signal strength is an average over N successive samples.

3. A method as claimed in claim 2 wherein each sample comprises a signal sample and a shadowing sample.

4. A method as claimed in claim 3 wherein said estimated value of signal strength is related to the auto-correlation of successive shadowing samples.

5. A method as claimed in any one of claims 1 to 4 wherein said step of setting said at least one threshold depends also on maximum signal strength P_{MAX} in the active set.

6. A method according to claim 5 wherein said adding threshold (TADD) is dependent on said estimated value and the value of said maximum signal strength P_{MAX} and said dropping threshold (TDROP) is fixed.

7. A method according to claim 6 wherein said adding threshold (TADD) has a lower bound.

8. A method according to claim 7 wherein said lower bound is the dropping threshold (TDROP).

9. A method according to any one of claims 6 to 8 wherein the said adding threshold (TADD) has no upper bound.

10. A method according to claim 4 wherein value of said dropping threshold (TDROP) is dependent on said estimated value and the value of said maximum signal strength P_{MAX} and said adding threshold (TADD) is set to said maximum signal strength P_{MAX}.

11. A method according to claim 9 wherein said dropping threshold (TDROP) has a lower bound.

12. A method according to claim 11 wherein said lower bound is the lowest acceptable signal strength Treceive.

13. A method of performing soft handover in a mobile communications system according to claim 1 and substantially as herein described.

14. A mobile communications system including a mobile terminal and a number of base stations adapted to perform the method of soft handover as claimed in any of claims 1 to 13.
